(19) United States
(12) Patent Application Publication
(10) Pub. No.: US 2021/0198034 A1
(43) Pub. Date: Jul. 1, 2021

(54) HOLDER AND SUBSTANCE CONTAINER FOR TREATMENT OF WASTE IN GARBAGE BIN

(71) Applicant: BinGuard Inc., North York (CA)

(72) Inventors: Steven B. Erlich, North York (CA); Dylan A. Goldstein, North York (CA)

(21) Appl. No.: 16/739,742

(22) Filed: Jan. 10, 2020

Related U.S. Application Data
(60) Provisional application No. 62/956,155, filed on Dec. 31, 2019.

(51) Int. Cl. B65F 1/08

(52) U.S. Cl. CPC B65F 1/08; B65F 2210/129

(57) ABSTRACT

In one aspect, there is provided a holder for holding a container of a substance to treat waste in an interior space of a garbage bin. The holder includes a housing having at least one mounting structure that is configured to mount to a garbage bin such that a rear wall portion of the housing is adjacent to a first wall portion of the garbage bin. A front wall portion of the housing is fixedly connected to a remainder of the housing and faces the interior space away from the rear wall portion. The housing includes a container receiving aperture shaped to hold the container, wherein the container receiving aperture has a mouth that faces upwards and is sized to receive the container. The holder includes a latching structure that prevents withdrawal of the container from the housing once the container is inserted into the container receiving aperture.

### CROSS REFERENCE TO RELATED APPLICATION

This application claims the benefit of U.S. Provisional Application No. 62/956,155 filed Dec. 31, 2019, the contents of which are incorporated herein by reference in their entirety.

### FIELD

The specification relates generally to waste treatment structures for garbage bins.

### BACKGROUND OF THE DISCLOSURE

It is known to provide waste treatment devices for the treatment of waste being held in garbage bins. Some waste treatment devices are difficult to maintain, as they require the user to touch portions of the device that have likely come into direct contact with the waste stored in the garbage bin, which is undesirable. Others are difficult to maintain because they require the removal of elements of the device in order to replace the waste treatment substance that is used to treat the waste. In devices where the removal of elements is required, there is the potential to lose these parts prior to their reinstallation on the waste treatment device. There is also the possibility of dropping the removed elements into the garbage bin itself. It would be advantageous to provide a waste treatment that ameliorates one or more of these problems or any of a range of other problems associated with some waste treatment devices of the prior art.

### SUMMARY OF THE DISCLOSURE

In one aspect, there is provided a holder for holding a container of a substance to treat waste in an interior space of a garbage bin. The holder includes a housing having at least one mounting structure that is configured to mount to a garbage bin such that a rear wall portion of the housing is adjacent to a first wall portion of the garbage bin. A front wall portion of the housing is fixedly connected to a remainder of the housing and faces the interior space away from the rear wall portion of the housing. The housing includes a container receiving aperture that is shaped to hold the container of the substance, wherein the container receiving aperture has a mouth that faces upwards and is sized to receive the container of the substance. The holder includes a latching structure that prevents withdrawal of the container of the substance from the housing once the container of the substance is inserted into the container receiving aperture.

In another aspect, there is provided a holder for holding a container of a substance to treat waste in an interior space of a garbage bin, the interior space being defined by a bin wall surface of the garbage bin. The holder includes a housing having at least one mounting structure that is configured to mount to a garbage bin, such that a rear wall portion of the housing is adjacent to a first wall portion of the garbage bin. The housing includes a container receiving aperture that is shaped to hold the container of the substance. The holder includes a latching structure that prevents withdrawal of the container of the substance from the housing once the container of the substance is inserted into the container receiving aperture. The housing has a bottom surface that is substantially perpendicular to the rear wall portion. The holder includes a first wheel and a second wheel that are rotatably connected to the housing and extend below the bottom surface of the housing, such that when the garbage bin is inverted, the wheels are rotatable upon impact with waste, to inhibit the waste from hanging up on the bottom surface of the housing.

In yet another aspect, there is provided a holder for holding a container of a substance to treat waste in an interior space of a garbage bin, the interior space being defined by a bin wall surface of the garbage bin. The holder includes a housing having at least one mounting structure that is configured to mount to a garbage bin such that a rear wall portion of the housing is adjacent to a first wall portion of the garbage bin. A front wall portion of the housing is fixedly connected to a remainder of the housing and faces the interior space away from the rear wall portion. The housing includes a container receiving aperture that is shaped to hold the container of the substance. The container receiving aperture has a mouth that faces upwards and is sized to receive the container of the substance. The housing includes a latching structure that prevents withdrawal of the container of the substance from the housing once the container of the substance is inserted into the container receiving aperture. The latching structure includes a first blocking member and a second blocking member. The first blocking member is movable between a blocking position and an unblocking position. In the blocking position the first blocking member is positioned to block movement of the container of the substance from a locked position to an unlocked position, and in the unblocking position the first blocking member permits movement of the container of the substance from the locked position to the unlocked position. In the locked position the second blocking member blocks movement of the container of the substance out of the container receiving aperture through the mouth, and in the unlocked position the first blocking member permits movement of the container of the substance out of the container receiving aperture through the mouth. The second blocking member is fixedly connected to the housing, and the container of the substance is insertable through the mouth of the container receiving aperture along a first container path, and is movable from the unlocked position to the locked position along a second container path that is generally perpendicular to the first container path.

In yet another aspect, there is provided a holder for holding a container of a substance to treat waste in an interior space of a garbage bin. The garbage bin has a lid. The holder includes a housing having at least one mounting structure that is configured to mount to a garbage bin such that a rear wall portion of the housing is adjacent to a first wall portion of the garbage bin. The housing includes a container receiving aperture that is shaped to hold the container of the substance. The container receiving aperture has a mouth that is sized to receive the container of the substance. The at least one mounting structure includes a first mounting structure that is a hook that is shaped to hook an edge of the garbage bin, and a plurality of mounting apertures for receiving mechanical fasteners for mounting the holder to the first wall portion of the garbage bin, and a second mounting structure that is shaped to mount to the first wall portion of the garbage bin and to hold the holder on the garbage bin independent of the hook. The hook has a break line therein that facilitates removal of at least a portion of the hook from the holder after the holder is mounted to the first wall portion of the garbage bin by the second mounting structure, so as to facilitate closure of the lid on the edge of the garbage bin to cover the interior space.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 is a perspective view of a garbage bin with a holder for a container of a substance, in accordance with one embodiment of the present disclosure.

FIG. 2 is an exploded perspective view of the holder and the container of the substance shown in FIG. 1.

FIG. 3 is perspective sectional view of the holder shown in FIG. 1, so as to show elements of a latching structure that holds the container of the substance in the holder.

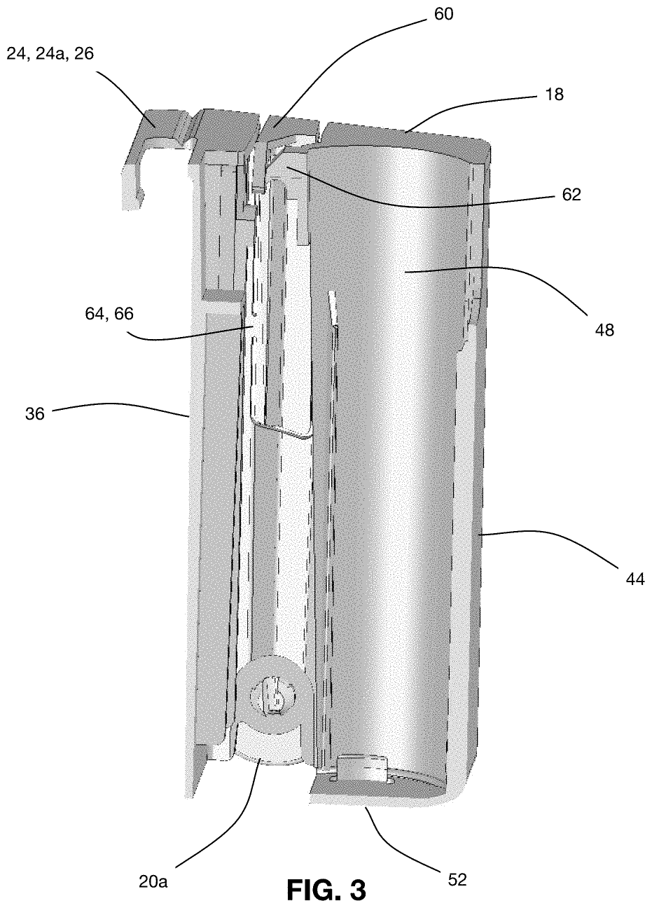

FIG. 4 is another perspective sectional view of the holder shown in FIG. 1, so as to show the elements of the latching structure shown in FIG. 3.

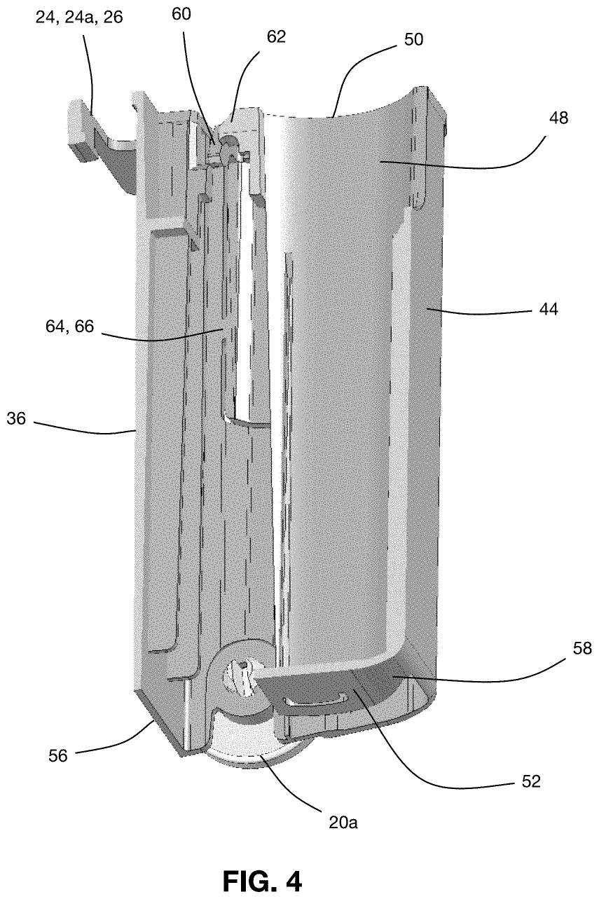

FIG. 5A is a magnified sectional front view of the latching structure, with a first blocking member in a blocking position, thereby holding the container of the substance in a locked position.

FIG. 5B is a magnified sectional front view of the latching structure showing the first blocking member in an unblocking position.

FIG. 6A is a magnified sectional side view illustrating movement of the container of the substance along a first container path to an unlocked position.

FIG. 6B is a magnified sectional side view showing the container of the substance in the unlocked position.

FIG. 6C is a magnified sectional side view showing the container of the substance in a locked position.

FIG. 7 is a perspective view of the garbage bin shown in FIG. 1, inverted in order to be emptied.

FIG. 8A is a view of the garbage bin with the lid open and the container of the substance is unactuated.

FIG. 8B is a view of the garbage bin with the lid closed and the container of the substance is actuated.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The use of terms relating to direction, such as upwards or the like, rear, rearward, backwards or the like, front, frontward, forward or the like, bottom, down, downwards or the like, side, sidewards, left or right or the like, are to be understood to be used in a non-limiting way and are relative terms to other portions of the object to which they refer or to other elements in their environment.

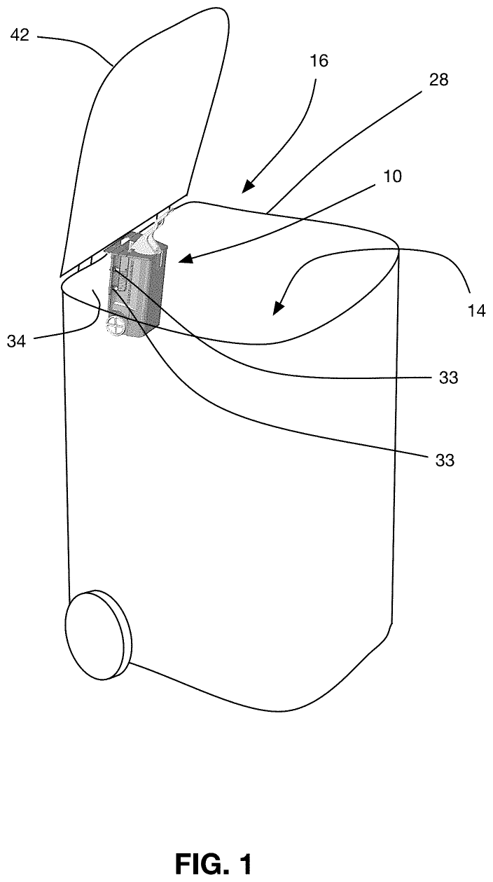

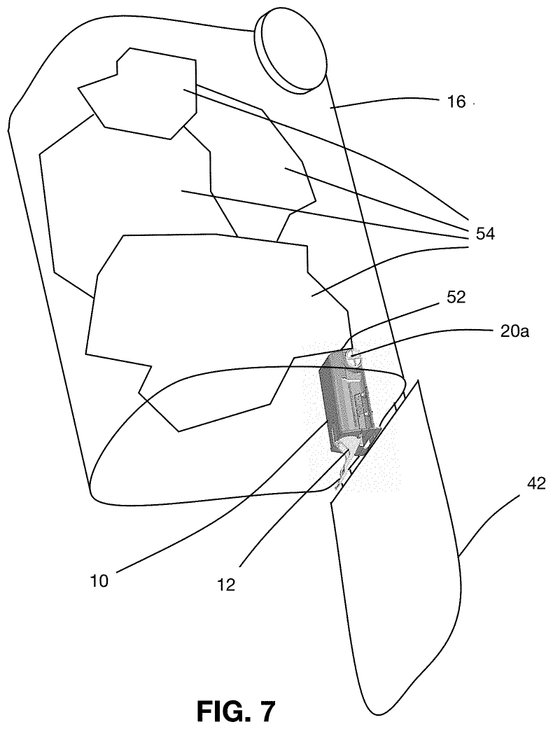

Reference is made to FIG. 1, which shows a holder 10 for a container of a substance 12 that is used to treat waste in an interior space 14 of a garbage bin 16. It will be noted that the garbage bin 16 is shown as being transparent in FIGS. 1 and 7. The holder 10 in the embodiment shown includes a housing 18 for holding the container of the substance 12, a first wheel 20a and a second wheel 20b, and a latching structure 22. For simplicity the container of the substance 12 may alternatively be referred to as simply the substance container 12.

The housing 18 includes at least one mounting structure 24 thereon that is configured to mount to the garbage bin 16. In the embodiment shown, the housing 18 includes a first mounting structure 24a and a second mounting structure 24b. The first mounting structure 24a is a hook 26 that hooks over the upper edge (shown at 28) of the garbage bin 16. The second mounting structure 24b may include a pair of flanges 30 that have fastener apertures 32 that permit mechanical fasteners 33 (FIG. 1) to pass therethrough into the wall (shown at 34) of the garbage bin 16. In the embodiment shown, the mounting structures 24a and 24b are used to mount the holder 10 to the garbage bin 16 such that a rear wall portion 36 of the housing 18 is adjacent to a first wall portion 38 of the garbage bin 16 (which in this instance is a rear wall portion of the garbage bin 16). The hook 26 includes a line of break line 40 which permits the hook 26 to be removed from the housing 18 once the fasteners are installed to hold the holder 10 to the garbage bin 16. By removing the hook 26 the hook 26 no longer obstructs the full closure of the lid (shown at 42) of the garbage bin 16. Put another way, the break line 40 facilitates removal of at least a portion of the hook 26 from the holder 10 after the holder 10 is mounted to the first wall portion 38 of the garbage bin 16 by the second mounting structure 24b, so as to facilitate closure of the lid 42 on the edge 28 of the garbage bin 16 to cover the interior space 14. The break line 40 may be provided in the form of a notch 44 in the hook 26, as shown, or, for example, in the form of a line of perforations, or by any other suitable means.

The housing 18 includes a front wall portion 44 that faces the interior space 14 away from the rear wall portion 36. The housing 18 further includes first and second side wall portions 46 that extend between the front wall portion 44 and the rear wall portion 36 and which face away from one another.

The housing 18 includes a container receiving aperture 48 that is shaped to hold the substance container 12. The container receiving aperture 48 has a mouth 50 that is sized to receive the substance container 12. In the embodiment shown, the mouth faces upwards. In other words, a user inserts the substance container 12 downwards through the mouth 50 into the container receiving aperture 48.

The housing 18 further includes a bottom surface 52 that is substantially perpendicular to the rear wall portion 36. The first wheel 20a and the second wheel 20b are rotatably connected to the housing 18 and extend below the bottom surface 52 of the housing 18. As a result, when the garbage bin 16 is inverted, (e.g. when being emptied into a garbage truck), as shown in FIG. 7, the wheels are rotatable upon impact with waste (shown at 54 in FIG. 7), to inhibit the waste 54 from hanging up on the bottom surface 52 of the housing 18. In a preferred embodiment, as shown, the first and second wheels 20a and 20b are positioned at a rear 56 of the bottom surface 52, so as to increase the likelihood that the waste 54 will roll towards a front 58 of the bottom surface 52. For clarity, the rear 56 of the bottom surface 52 is the end of the bottom surface 52 that is closest to the rear wall portion 36, and the front 58 is the end that is closest to the front wall portion 44. Thus, by increasing the likelihood that the waste 54 rolls towards the front 58 of the bottom surface 52, the likelihood is increased that the waste 54 will not hang up on the bottom surface 52 and will fall out of the inverted garbage bin 16.

The latching structure 22 holds the substance container 12 in place in the container receiving aperture 48, such that, when the garbage bin 16 is inverted during emptying, as shown in FIG. 7, the latching structure 22 prevents the substance container 12 from falling out of the holder 10, since the mouth 50 would be oriented in such a way that the substance container 12 would be otherwise able to fall out of the holder 10.

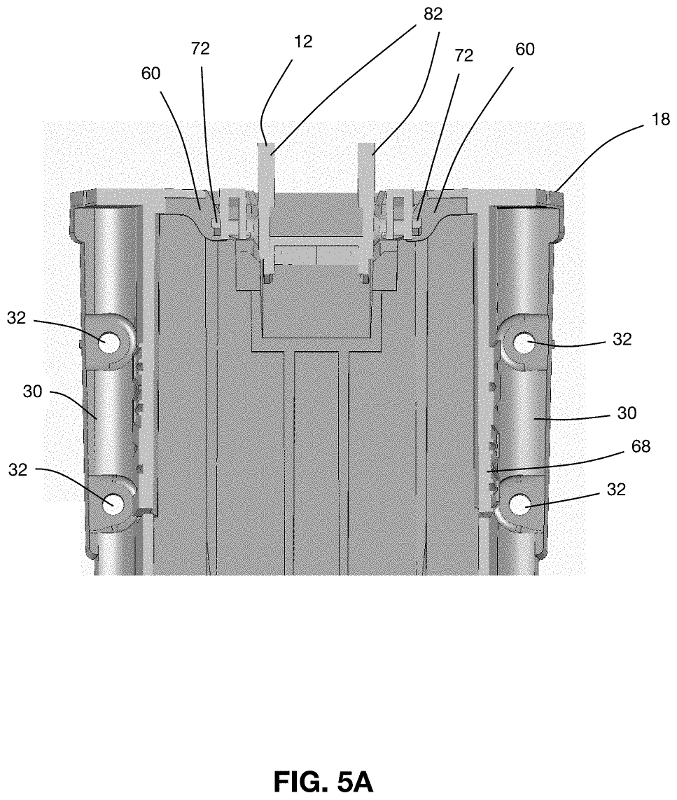

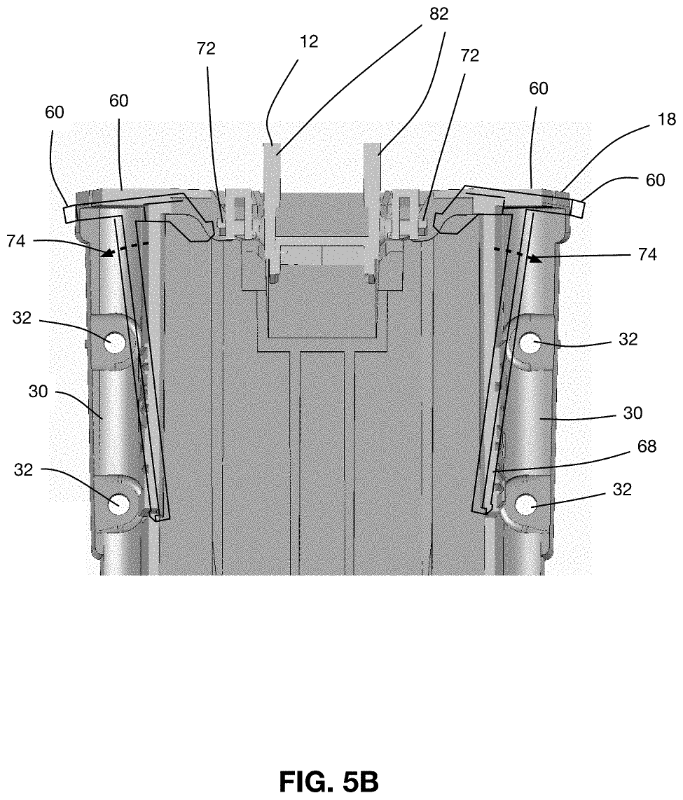

In the embodiment shown, the latching structure 22 includes a first blocking member 60 and a second blocking member 62 on each side of the housing 18. The first blocking member 60 is movable between a blocking position (shown in FIG. 5A) and an unblocking position (shown in FIG. 5B). In the blocking position the first blocking member 60 is positioned to block movement of the substance container 12 from a locked position to an unlocked position. It will be noted that only a top portion shown at 82 of the substance container 12 is shown in FIGS. 5A and 5B. Additionally, in FIG. 5B, the first blocking member is shown in both the blocking position and in outline only, in the unblocking position. In the unblocking position the first blocking member permits movement of the substance container 12 from the locked position to the unlocked position. In the locked position the second blocking member blocks movement of the substance container 12 out of the container receiving aperture through the mouth. As a result, the second blocking member prevents the substance container 12 from falling out of the holder 10 when the garbage bin 16 is inverted as shown in FIG. 7, for emptying. In the unlocked position the first blocking member 60 permits movement of the substance container 12 out of the container receiving aperture 48 through the mouth 50, thereby permitting the substance container 12 to be removed and replaced by a user. It will be noted that the second blocking member 62 is fixedly connected to the housing 18. As a result, it is relatively strong and rigid so as to prevent it from flexing or bending out of the way by the aggressive shaking that the garbage bin 16 may be subjected to during emptying.

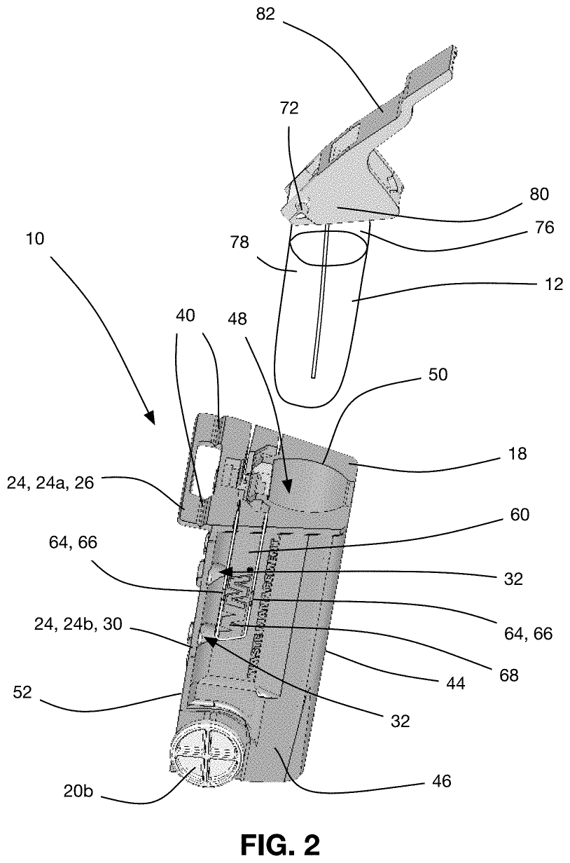

The latching structure 22 further includes a first blocking member biasing member 64 that biases the first blocking member 60 towards the blocking position. In the present example, the first blocking member 60 is integrally connected with the associated side wall portion 46 of the housing 18 by two ears 66. The two ears 66 act as living hinges and as springs, and therefore together act as the first blocking member biasing member 64 by resiliently resisting pivoting of the first blocking member 60 away from a home position shown in FIG. 5A, which is the blocking position. A portion of the first blocking member 60 that extends below the ears 66 has a pressure surface 68 thereon (FIG. 2), that is pressable by a user to move the first blocking member 60 from the blocking position to the unblocking position. In the present example, pressing on the pressure surface 68 causes pivoting of the first blocking member 60 about the ears 66, thereby bringing the first blocking member 60 from the blocking position to the unblocking position.

It will be noted that the pressure surface 68 is generally perpendicular to the front wall portion 44 of the housing 18. Additionally, it will be noted that the pressure surface 68 is recessed relative to at least part of the side wall portion 44. As a result of these features the pressure surface 68 is less likely to contact the waste 54 both when the waste 54 is sitting in the garbage bin 16 and when the waste 54 is being emptied from the garbage bin 16.

It will be noted that the pressure surfaces 68 and the side wall portions 46 do not have to be strictly perpendicular to the front wall portion 44 or to the rear wall portion 36. They may be off of perpendicular relative to the front wall portion 44 by an angle of as much as 20 degrees, for example. In the example shown, the side wall portions 46 extend at an angle of about 107 degrees from the front wall portion 44.

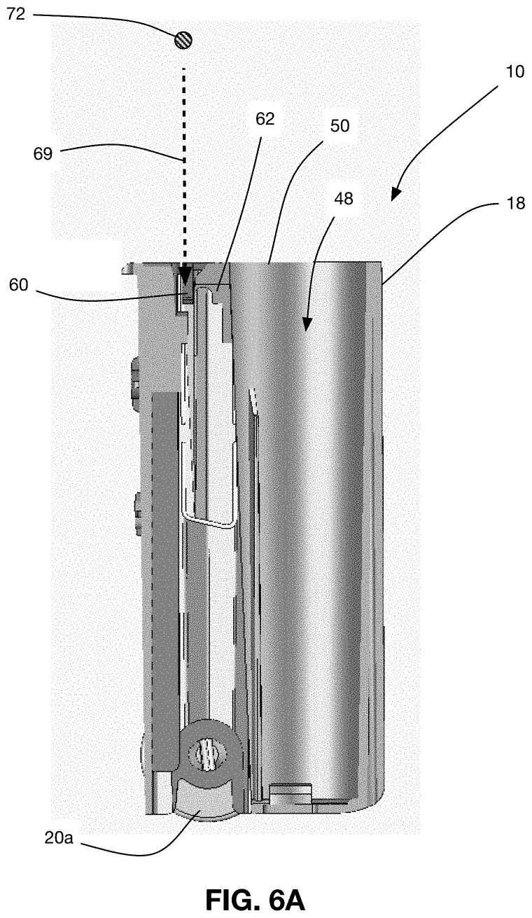

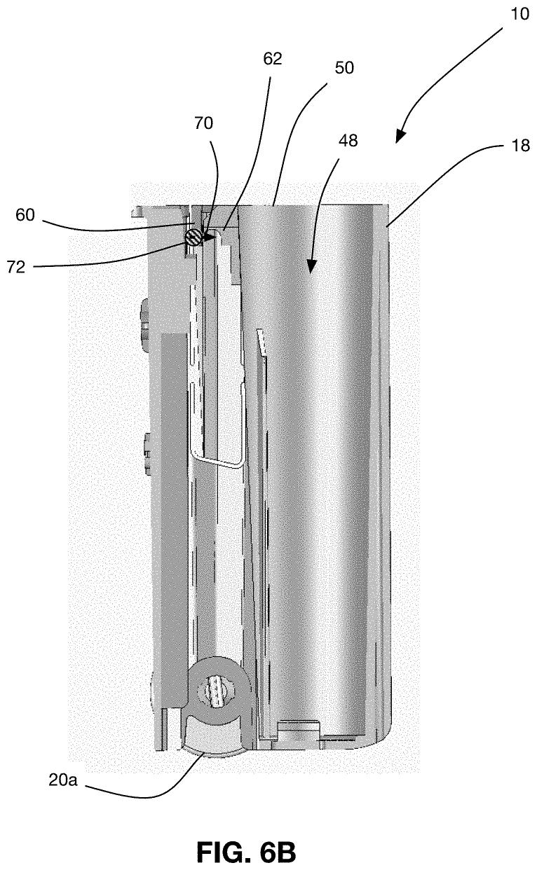

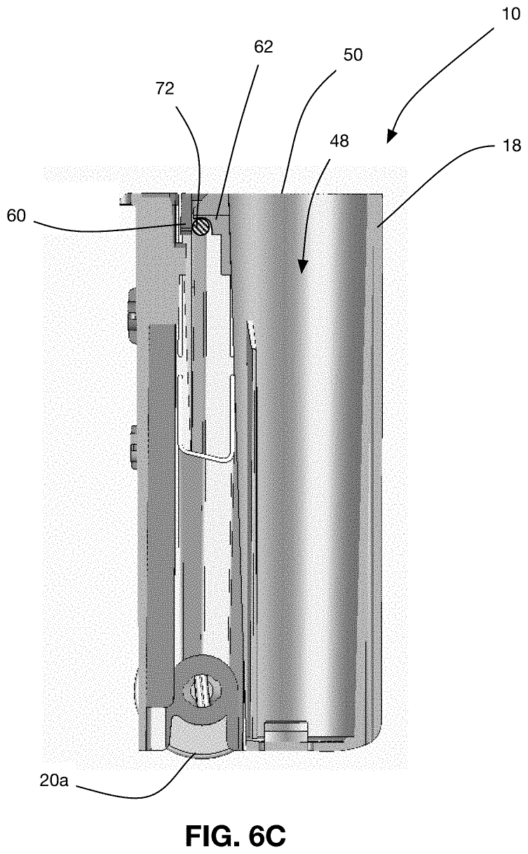

The operation of installing the substance container 12 into the holder 10 may be as follows. The user inserts the substance container 12 into the container receiving aperture 48 along a first container path shown at 69 in FIG. 6A. The substance container 12 is represented only by a projection shown at 72 (shown at 72 in FIG. 2 for greater clarity). Insertion of the substance container 12 through the mouth 50 pushes aside the first blocking members 60 due to the presence of chamfers, also referred to as lead-in, on the tips of the first blocking members 60. The first container path 69 brings the substance container 12 (and the projection 72) to the unlocked position shown in FIG. 6B. From the unlocked position, the substance container 12 is movable along a second container path 70 that is generally perpendicular to the first container path 69 from the unlocked position to the locked position shown in FIG. 6C, where the substance container 12 (and the projection 72 specifically) is captured underneath each of the second blocking members 62.

It can be seen that the first blocking member 60 is movable between the blocking position and the unblocking position along a first blocking member path shown at 74. The second container path is generally perpendicular to the first blocking member path 74. As a result, any forces that are applied by the substance container 12 to the first blocking member 60 are generally orthogonal to the range of movement of the first blocking member 60, and therefore are unlikely to urge the first blocking member 60 away from the blocking position, thereby rendering it unlikely for the substance container 12 to be removable from the locked position.

It will be noted that container receiving aperture 48 is shaped in such a way that it can only fully receive the substance container 12 in one orientation, so as to ensure that the substance container 12 is oriented in the proper direction for spraying the substance into the garbage bin 16.

It will be noted that the first container path 69 and the second container path 70 do not need to be strictly perpendicular to one another. For example, the second container path 70 may be up to 45 degrees or more in some instances off of perpendicular from the first container path 69. Thus, ‘generally perpendicular’ means ‘up to 45 degrees off of perpendicular’ in this context, or more in some instances.

Similarly, it will be noted that the second container path 70 and the first blocking member path 74 do not need to be strictly perpendicular to one another. For example, the second container path 70 may be up to 45 degrees or more in some instances off of perpendicular from the first container path 69. Thus, ‘generally perpendicular’ means ‘up to 45 degrees off of perpendicular’ in this context, or more in some instances.

To remove the substance container 12 from the holder 10, a user presses on the pressure surfaces 68 causing the first blocking members 60 to move to the unblocking positions. The user can then move the substance container 12 from the locked position to the unlocked position along the second container path 70 and can then withdraw the substance container 12 from the container receiving aperture 48 through the mouth 50.

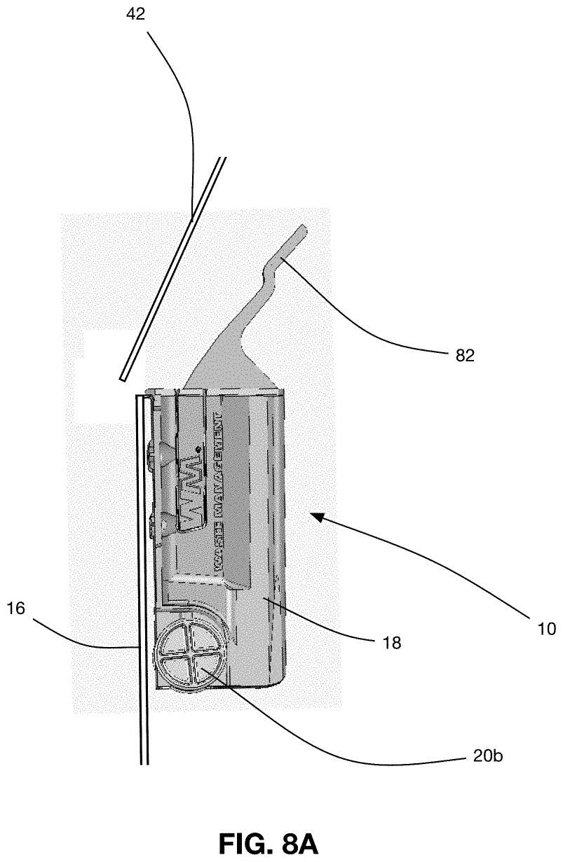

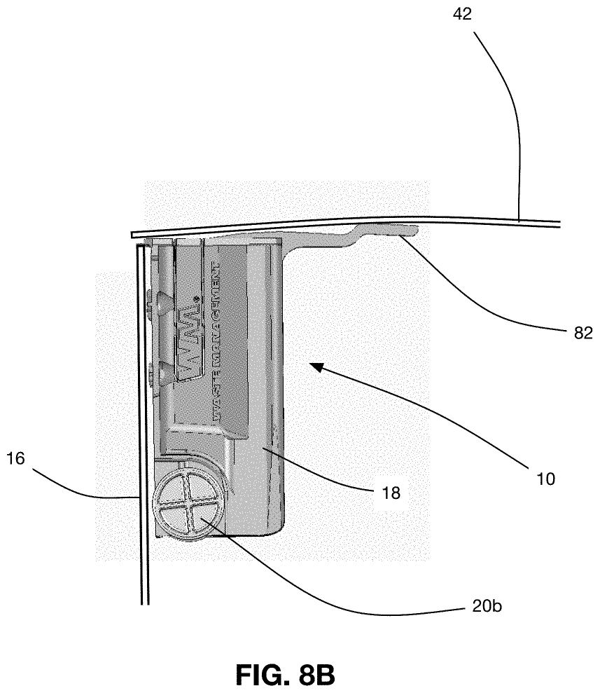

The substance container 12 itself, shown in FIG. 8A, includes a chamber 76 for holding the substance (shown at 78) and includes a spray pump 80 that is activated by an actuator 82. The actuator 82 may be in the form of a lever that is pivotally mounted to a cap on the substance container 12, or a pushbutton that is slidable on the cap of the substance container 12, or any other suitable type of actuation element. When the lid 42 of the garbage bin 16 is open, the actuator 82 permits the actuator to move to an unactuated position shown in FIG. 8A. When the lid 42 is closed, it drives the actuator 82 to move to the actuated position shown in FIG. 8B, causing the substance container 12 to spray the substance 78 on any waste 54 contained in the garbage bin 16. Thus, each time waste 54 is inserted into the garbage bin 16, it is sprayed by the substance container 12. The actuator 82 may be biased towards the unactuated position by a spring or other actuator biasing member, as is common in the art of spray pumps. The substance in the example shown is in the form of a sprayable liquid, however it may take any other suitable form, and may be used to control odour from the waste 54 and/or may be used to repel, or kill insects and/or bacteria.

While the housing 18 is shown in the example embodiment as generally being a quadrilateral (specifically a trapezoid) in cross-section, and therefore has four distinct faces that constitute the front, rear and side wall portions 44, 36, and 46, respectively. However, the housing 18 could alternatively have any other shape, such as generally circular, and still be considered to have front, rear, and side wall portions.

It will be noted that the feature of the hook 26 with the break line 40, need not be provided only in combination with a second mounting structure that includes mounting apertures for receiving mechanical fasteners. It is alternatively possible for the second mounting structure to be any other suitable mounting structure that can hold the holder 10 on the garbage bin 16 independent of the hook 26. Furthermore, the feature of providing the hook 26 with the break line 40 and the second mounting structure 24b may be provided on a holder that has a different latching structure than that which is shown, and a different container receiving aperture than that which is shown. For example, a holder with the hook 26 with the break line 40 and a second mounting structure 24b as described immediately above, could be advantageously provided even if the front wall of the housing 18 is not fixedly connected to a remainder of the housing 18 (i.e. even if the front wall of the housing is removable from a remainder of the housing) and even if the latching structure does not include blocking members that are fixed to the housing and instead only includes movable blocking members, and even if the second mounting structure 24b is configured to mount the holder 10 the exterior face of the garbage bin 16.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A holder for holding a container of a substance to treat waste in an interior space of a garbage bin, the holder comprising:
a housing having at least one mounting structure that is configured to mount to a garbage bin such that a rear wall portion of the housing is adjacent to a first wall portion of the garbage bin,
wherein a front wall portion of the housing is fixedly connected to a remainder of the housing and faces the interior space away from the rear wall portion of the housing,
wherein the housing includes a container receiving aperture that is shaped to hold the container of the substance, wherein the container receiving aperture has a mouth that faces upwards and is sized to receive the container of the substance,
a latching structure that prevents withdrawal of the container of the substance from the housing once the container of the substance is inserted into the container receiving aperture.

2. A holder as claimed in claim 1, wherein the latching structure includes a first blocking member and a second blocking member, wherein the first blocking member is movable between a blocking position and an unblocking position, wherein in the blocking position the first blocking member is positioned to block movement of the container of the substance from a locked position to an unlocked position, and in the unblocking position the first blocking member permits movement of the container of the substance from the locked position to the unlocked position,
wherein in the locked position the second blocking member blocks movement of the container of the substance out of the container receiving aperture through the mouth, and wherein in the unlocked position the first blocking member permits movement of the container of the substance out of the container receiving aperture through the mouth.

3. A holder as claimed in claim 2, wherein the latching structure includes a first blocking member biasing member that biases the first blocking member towards the blocking position.

4. A holder as claimed in claim 2, wherein the second blocking member is fixedly connected to the housing and the container of the substance is insertable through the mouth of the container receiving aperture along a first container path, and is movable from the unlocked position to the locked position along a second container path that is generally perpendicular to the first container path.

5. A holder as claimed in claim 4, wherein the first blocking member is movable between the blocking position and the unblocking position along a first blocking member path, and the second container path for the container of the substance is generally perpendicular to the first blocking member path.

6. A holder as claimed in claim 3, wherein the first blocking member includes a pressure surface that is pressable by a user to move the first blocking member from the blocking position to the unblocking position, wherein the pressure surface is generally perpendicular to the front wall portion of the housing.

7. A holder as claimed in claim 6, wherein the housing includes a side wall portion that extends between the front wall portion of the housing and the rear wall portion of the housing, and wherein the pressure surface is recessed relative to at least part of the side wall portion.

8. A holder as claimed in claim 7, wherein the latching structure includes two of the first blocking member and two of the second blocking member and two of the side wall portions which face away from one another, and wherein one of the two first blocking members is positioned on one of the two side wall portions and the other of the two first blocking members is positioned on the other of the two side wall portions.

9. A holder as claimed in claim 1, wherein the housing has a bottom surface that is substantially perpendicular to the rear wall portion of the housing and wherein the holder further comprises a first wheel and a second wheel that are rotatably connected to the housing and extend below the bottom surface of the housing, such that when the garbage bin is inverted, the wheels are rotatable upon impact with waste, to inhibit the waste from hanging up on the bottom surface of the housing.

10. A holder as claimed in claim 9, wherein the housing includes a first side wall portion and a second side wall portion, wherein the first and second side wall portions extend between the front wall portion of the housing and the rear wall portion of the housing, wherein the first wheel is rotatably connected to the first side wall portion and the second wheel is rotatably connected to the second side wall portion.

11. A holder as claimed in claim 9, wherein the bottom surface has a rear and a front, and the first and second wheels are positioned closer to the rear of the bottom surface than to the front of the bottom surface.

12. A holder as claimed in claim 11, wherein the bottom surface has a rear and a front, and the first and second wheels are positioned at the rear of the bottom.

13. A holder as claimed in claim 1, wherein the at least one mounting structure includes a hook that is shaped to hook an edge of the garbage bin, and a plurality of mounting apertures for receiving mechanical fasteners for mounting the holder to the first wall portion of the garbage bin.

14. A holder as claimed in claim 13, wherein the hook has a break line therein that facilitates removal of at least a portion of the hook from the holder after the holder is mounted to the first wall portion of the garbage bin by the mechanical fasteners.

15. A holder for holding a container of a substance to treat waste in an interior space of a garbage bin, the interior space being defined by a bin wall surface of the garbage bin, the holder comprising:
a housing having at least one mounting structure that is configured to mount to a garbage bin, such that a rear wall portion of the housing is adjacent to a first wall portion of the garbage bin, wherein the housing includes a container receiving aperture that is shaped to hold the container of the substance;
a latching structure that prevents withdrawal of the container of the substance from the housing once the container of the substance is inserted into the container receiving aperture, wherein the housing has a bottom surface that is substantially perpendicular to the rear wall portion; and
a first wheel and a second wheel that are rotatably connected to the housing and extend below the bottom surface of the housing, such that when the garbage bin is inverted, the wheels are rotatable upon impact with waste, to inhibit the waste from hanging up on the bottom surface of the housing.

16. A holder as claimed in claim 15, wherein the housing includes a first side wall portion and a second side wall portion, wherein the first and second side wall portions extend between the front wall portion of the housing and the rear wall portion of the housing, wherein the first wheel is rotatably connected to the first side wall portion and the second wheel is rotatably connected to the second side wall portion.

17. A holder as claimed in claim 15, wherein the bottom surface has a rear and a front, and the first and second wheels are positioned closer to the rear of the bottom surface than to the front of the bottom surface.

18. A holder as claimed in claim 17, wherein the bottom surface has a rear and a front, and the first and second wheels are positioned at the rear of the bottom.

19. A holder for holding a container of a substance to treat waste in an interior space of a garbage bin, the interior space being defined by a bin wall surface of the garbage bin, the holder comprising:
a housing having at least one mounting structure that is configured to mount to a garbage bin such that a rear wall portion of the housing is adjacent to a first wall portion of the garbage bin,
wherein a front wall portion of the housing is fixedly connected to a remainder of the housing and faces the interior space away from the rear wall portion;
wherein the housing includes a container receiving aperture that is shaped to hold the container of the substance, wherein the container receiving aperture has a mouth that faces upwards and is sized to receive the container of the substance; and
a latching structure that prevents withdrawal of the container of the substance from the housing once the container of the substance is inserted into the container receiving aperture,
wherein the latching structure includes a first blocking member and a second blocking member, wherein the first blocking member is movable between a blocking position and an unblocking position, wherein in the blocking position the first blocking member is positioned to block movement of the container of the substance from a locked position to an unlocked position, and in the unblocking position the first blocking member permits movement of the container of the substance from the locked position to the unlocked position,
wherein in the locked position the second blocking member blocks movement of the container of the substance out of the container receiving aperture through the mouth, and wherein in the unlocked position the first blocking member permits movement of the container of the substance out of the container receiving aperture through the mouth,
wherein the second blocking member is fixedly connected to the housing, and the container of the substance is insertable through the mouth of the container receiving aperture along a first container path, and is movable from the unlocked position to the locked position along a second container path that is generally perpendicular to the first container path.

20. A holder as claimed in claim 19, wherein the first blocking member is movable between the blocking position and the unblocking position along a first blocking member path, and the second container path for the container of the substance is generally perpendicular to the first blocking member path.
